(19) United States
(12) Patent Application Publication
(10) Pub. No.: US 2025/0362640 A1
(43) Pub. Date: Nov. 27, 2025

(54) LUBRICANT APPLICATION DEVICE AND IMAGE FORMING APPARATUS

(71) Applicant: Konica Minolta, Inc., Tokyo (JP)

(72) Inventor: Tatsuyuki SASAKI, Toyokawa-shi (JP)

(21) Appl. No.: 19/214,596

(22) Filed: May 21, 2025

(30) Foreign Application Priority Data
May 24, 2024 (JP) 2024-085028

(51) Int. Cl. G03G 21/00; A46B 11/00

(52) U.S. Cl. CPC G03G 21/007; A46B 11/0006; G03G 21/0011; A46B 2200/20

(57) ABSTRACT

A lubricant application device includes an application brush configured to apply a lubricant to a surface of an application target by bringing brush bristles into sliding contact with the surface while the surface of the application target is being rotated. The application brush is configured to come into pressure contact with and separate from the application target, and the application brush is configured to come into pressure contact with and separate from the lubricant.

### CROSS REFERENCE TO RELATED APPLICATION

The present invention claims priority under 35 U.S.C. § 119 to Japanese Application No. 2024-085028, filed on May 24, 2024, the entire contents of which being incorporated herein by reference.

### TECHNICAL FIELD

The present invention relates to a lubricant application device and an image forming apparatus.

### BACKGROUND OF THE INVENTION

In a conventional image forming apparatus, a lubricant is applied to a photoconductor on which a toner image is formed and to an image forming rotary member of an intermediate transfer member, thereby reducing the friction coefficient of the surface of the image forming rotary member.

A brush treatment device described in JP 2002-258668 A includes a lubricant application device for applying a lubricant to an intermediate transfer belt. The lubricant application device includes a brush roller that comes into contact with the intermediate transfer belt, a solid lubricant, a pressure spring that urges the lubricant through a bracket, and a holder case that accommodates the lubricant, the bracket, and the pressure spring.

The lubricant application device has a lubricant releasing unit capable of releasing the lubricant by a brush roller. In the lubricant releasing unit, a release member is inserted into a bracket that holds the lubricant. The lubricant releasing unit moves the lubricant in a release direction by the release member and detachably locks and fixes the release member at a release position of the lubricant.

In the lubricant application device described in JP 2002-258668 A, the brush roller and the holder case are integrated, and the holder case is rotated about a fulcrum as a rotation center, so that the brush roller can be brought into contact with and separated from the surface of the intermediate transfer belt. The rotation of the holder case is performed by a contact/separation control mechanism as a brush-like member contact/separation unit controlled by a swing lever and a half-turn cam that pushes up the swing lever toward the rotation direction of the holder case to swing the swing lever.

### SUMMARY OF THE INVENTION

However, the lubricant releasing unit of the brush treatment device as described above has a structure in which only the lubricant is separated from the brush roller. Therefore, in the brush treatment device, the brush roller is always in pressure contact with the intermediate transfer belt, causing the bristles of the brush to collapse and become deformed. Thus, the lubricant applied to the photoconductor or the intermediate transfer member becomes uneven, resulting in uneven density of the image.

Further, the lubricant releasing unit separates the brush roller and the lubricant using the contact/separation control mechanism, which includes the swing lever and the half-turn cam, for each unit where the brush roller and the holder case are integrated. For this reason, in the lubricant releasing unit, since the contact/separation control mechanism having the swing lever and the half-turn cam needs to be installed, an installation space for the contact/separation control mechanism is required, and thus there is a problem that the entire mechanism is increased in size.

The present invention has been made in view of the above problems, and an object of the present invention is to provide a lubricant application device and an image forming apparatus that can separate a application brush from an application target and a lubricant and can be disposed in a limited space.

To achieve at least one of the abovementioned objects, according to an aspect of the present invention, a lubricant application device reflecting one aspect of the present invention comprises an application brush configured to apply a lubricant to a surface of an application target by bringing brush bristles into sliding contact with the surface while the surface of the application target is being rotated, wherein the application brush is configured to come into pressure contact with and separate from the application target, and the application brush is configured to come into pressure contact with and separate from the lubricant.

Further, to achieve at least one of the abovementioned objects, according to an aspect of the present invention, an image forming apparatus reflecting one aspect of the present invention includes the above-described lubricant application device.

### BRIEF DESCRIPTION OF THE DRAWINGS

The advantages and features provided by one or more embodiments of the invention will become more fully understood from the detailed description given hereinbelow and the appended drawings which are given by way of illustration only and thus are not intended as a definition of the limits of the present invention.

FIG. 1 is a schematic structural view illustrating an overall configuration of an image forming apparatus according to an embodiment of the present invention.

FIG. 2 is a schematic structural view illustrating an image forming section and a lubricant application device.

FIG. 3 is a schematic perspective view illustrating a unit of the lubricant application device.

FIG. 4 is an explanatory view illustrating a state in which an application brush of the lubricant application device is separated from a photoconductor as an application target and a lubricant (lubricant bar).

FIG. 5 is an explanatory view illustrating a state in which the application brush of the lubricant application device is applied to the photoconductor as the application target.

FIG. 6 is an explanatory view illustrating a state in which a fixing member of the lubricant application device is attached to the unit.

FIG. 7 is an explanatory view illustrating a state in which the application brush is separated from the photoconductor by operating the lever.

FIG. 8 is an explanatory view illustrating a state in which the application brush is brought into pressure contact with the photoconductor by operating the lever.

FIG. 9 is an explanatory view (a front view of a main part) illustrating an installation state of a fixed bearing when the application brush is separated from the photoconductor.

FIG. 10 is an explanatory view (a rear view of a main part) illustrating an installation state of a plate member when the application brush is separated from the photoconductor.

FIG. 11 is a front view of a main part illustrating the unit.

### DETAILED DESCRIPTION

Hereinafter, one or more embodiments of the present invention will be described with reference to the drawings. However, the scope of the invention is not limited to the disclosed embodiments.

An embodiment of the present invention will be described in detail with reference to appropriate drawings. Note that common members are denoted by the same reference signs in the drawings.

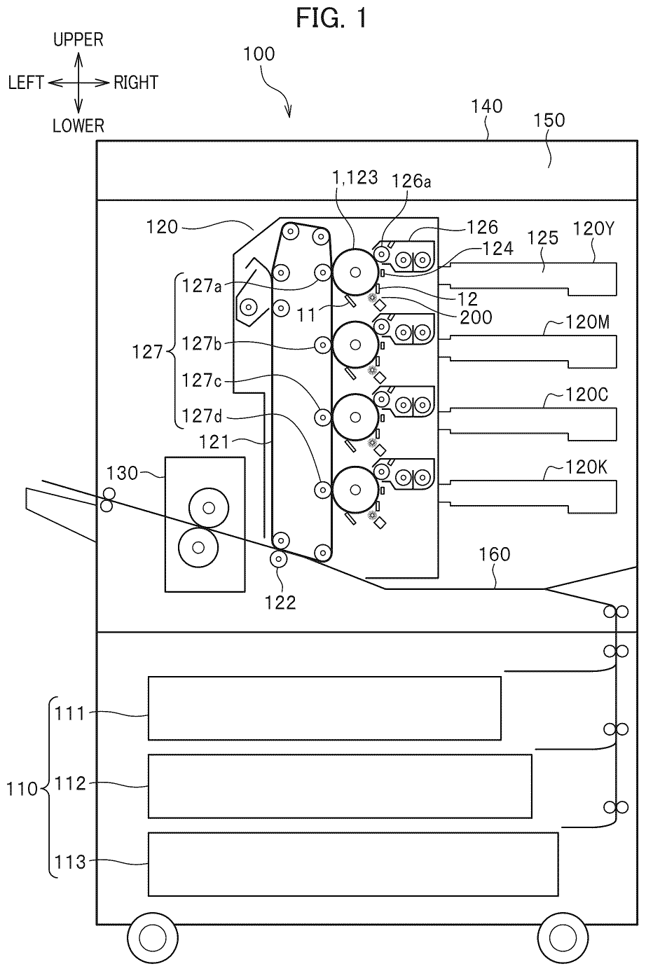

FIG. 1 is a schematic structural view illustrating an overall configuration of an image forming apparatus 100 according to an embodiment of the present invention.

### «Image Forming Apparatus»

The image forming apparatus 100 shown in FIG. 1 includes, for example, a sheet feeding section 110, an image forming section 120, a fixing section 130, an operation display section 140, an image reading device 150, a control unit (not shown), a storage unit, and a lubricant application device 200.

### <Sheet Feeding Unit>

The sheet feeding section 110 includes a plurality of sheet feed trays 111, 112, 113 for storing sheets. The sheet feed trays 111, 112, 113 store sheets having different sizes. The sheets stored in the sheet feed trays 111, 112, 113 are conveyed to the image forming section 120 through a predetermined conveyance path 160.

### <Image Forming Section>

The image forming section 120 forms an image of each color toner of yellow (Y), magenta (M), cyan (C), and black (K) on a sheet based on an image forming job transmitted from an external device, for example. The image forming section 120 may be configured to form a monochrome image on a sheet. The image forming section 120 includes image forming units 120Y, 120M, 120C, 120K to form images with yellow (Y), magenta (M), cyan (C), and black (K) toners on a sheet, an intermediate transfer member 121, and a secondary transfer roller 122.

### <Image Forming Unit>

As shown in FIG. 1, the image forming units 120Y, 120M, 120C, and 120K have the same configuration. Each of the image forming units 120Y, 120M, 120C, and 120K includes a photoconductor 123, a charging unit 124, an exposure unit 125, a developing unit 126, and a primary transfer unit 127.

### <Intermediate Transfer Member>

The intermediate transfer member 121 is formed of an endless belt and travels at a constant speed in the direction of an arrow 121a. The intermediate toner image formed by sequentially superimposing (primarily transferring) the toner images of the respective colors on the intermediate transfer member 121 is secondarily transferred to the sheet as the intermediate transfer member 121 is pressed against the sheet by the secondary transfer roller 122. Thereafter, the sheet is conveyed to the fixing section 130.

### <Primary Transfer Section>

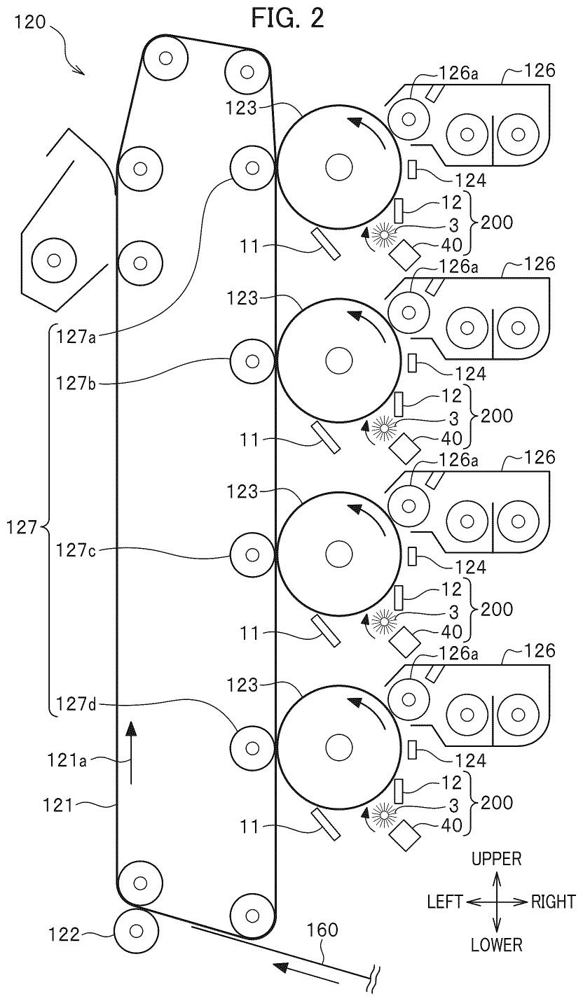

FIG. 2 is a schematic structural view illustrating the image forming section 120 and the lubricant application device 200.

As shown in FIG. 2, the primary transfer section 127 is a section where a toner image formed on the photoconductor 123 is transferred to the intermediate transfer member 121 in ta transfer region. The primary transfer section 127 includes primary transfer modules 127a, 127b, 127c, and 127d for yellow, magenta, cyan, and black, respectively.

### <Secondary Transfer Roller>

The secondary transfer roller 122 is disposed outside the intermediate transfer member 121 and is positioned so that a sheet can pass between the secondary transfer member 121 and the intermediate transfer member 121. The toner images formed by the image forming units 120Y to the 120K are transferred onto the intermediate transfer member 121 by the primary transfer modules 127a to 127d, and a color toner image is formed in which yellow, magenta, cyan, and black layers are superimposed one on another. The formed toner image is transferred onto the conveyed sheet by the secondary transfer roller 122.

### <Photoconductor as Application Target>

The photoconductor 123 is a drum-shaped member, which is an image bearing member to be rotationally driven and is an application target to which a lubricant is applied by an application brush 3 of the lubricant application device 200 described later. On the surface of the photoconductor 123, an electrostatic latent image of each color component is formed due to a potential difference from the surroundings.

### <Charging Unit>

The charging unit 124 is a member for uniformly charging the surface of the photoconductor 123. The charging unit 124 charges the surface of the photoconductor 123 to a constant potential using a charger.

### <Exposure Unit>

As shown in FIG. 1, the exposure unit 125 is a member for exposing the surface of the photoconductor 123 charged by the charging unit 124 to form an electrostatic latent image. The exposure unit 125 includes, for example, a semiconductor laser, and irradiates the photoconductor 123 with laser light corresponding to an image of each color component.

### <Developing Unit>

As shown in FIG. 2, the developing unit 126 is a member for visualizing the electrostatic latent image formed by the exposure unit 125 (see FIG. 1) using a developer containing a toner. The developing unit 126 contains developer of each of the color components and forms a toner image by visualizing the electrostatic latent image by causing toner of each of the color components to adhere to the surface of the photoconductor 123.

To be more specific, the developing unit 126 includes a developing sleeve 126a disposed to face the photoconductor 123 via a developing region. The developing sleeve 126a is applied with, for example, a DC developing voltage having the same polarity as the charge polarity of the charging unit 124 or a developing bias in which a DC voltage having the same polarity as the charge polarity of the charging unit 124 is superimposed on an AC voltage. As a result, a reversal developing process is performed in which the toner is made to adhere to the electrostatic latent image formed by the exposure unit 125 (see FIG. 1).

The developer used herein contains toner and a carrier for charging the toner. The toner is not particularly limited, and a generally used known toner can be used. The toner may be prepared by adding a colorant and optionally a charge control agent, a release agent, etc., to a binder resin and treating the mixture with an external additive.

The toner image formed on the photoconductor 123 by the developing unit 126 is conveyed to a transfer region formed between the primary transfer section 127 and the photoconductor 123. In the transfer region, a voltage having a polarity opposite to that of the toner is applied to the primary transfer section 127. The toner image on the photoconductor 123 is transferred onto the intermediate transfer member 121.

The toner remaining on the photoconductor 123 without being transferred onto the intermediate transfer member 121 in the transfer region is conveyed to the lubricant application device 200 and is collected by the lubricant application device 200.

Further, the photoconductor 123 from which the toner on the surface is collected by the lubricant application device 200 is charged again by the charging unit 124, and the next electrostatic latent image is formed to repeat the formation of the toner image.

### <Lubricant Application Device>

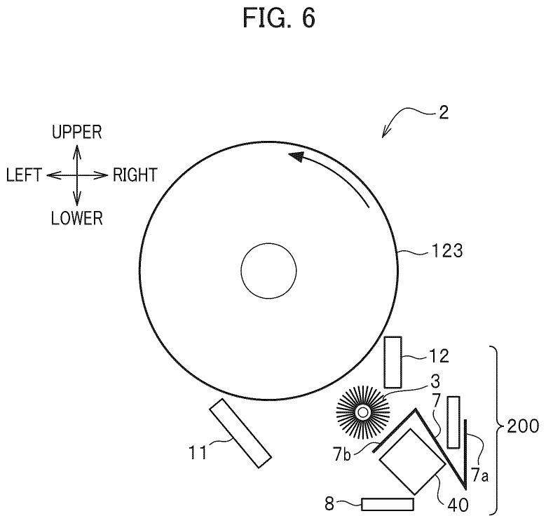

The lubricant application device 200 is a device for applying a lubricant to the photoconductor 123. The lubricant application device 200 includes an application brush 3, a lubricant bar 40, and a blade 12, and constitutes a part of a photoconductor unit 2 together with the photoconductor 123 and a housing 8 in FIG. 6. The lubricant application device 200 will be described in more detail later.

### <Fixing Section>

As shown in FIG. 1, the fixing section 130 applies heat and pressure to the sheet on which the toner image has been formed by the image forming section 120 to fix the toner image on the sheet.

### <Operation Display Section>

The operation display section 140 includes a display unit that displays various kinds of information on a display screen, and an operation unit that is used for inputting various instructions by a user. The operation display section 140 is constituted by, for example, a liquid-crystal display (LCD) with a touch panel, and functions as a display unit and an operation unit.

### <Image Reading Device>

The image reading device 150 is a device for generating image data of a document. The image reading device 150 includes a light source, an optical system, and an image sensor, which are not shown in the drawings.

The light source irradiates a document placed on a reading surface. The reflected light passes through the optical system and forms an image on an image sensor moved to the reading position.

The image sensor is formed of, for example, a line image sensor, and generates an electric signal (electro-optical conversion) according to the intensity of the reflected light. The generated electric signal is subjected to image processing and then input to the image forming section 120. The image processing includes A/D conversion, shading correction, filter processing, image compression processing, and the like.

### <Control Unit>

The control unit (not shown) includes, for example, a central processing unit (CPU), a random access memory (RAM), and the like. The CPU of the control unit reads out various programs such as a system program and a processing program stored in the storage unit (not shown), develops the programs in the RAM, and executes various processing such as an image forming processing according to the developed programs.

### <Storage Unit>

The storage unit (not shown) includes, for example, a hard disk drive (HDD), a semiconductor nonvolatile memory, or the like. The storage unit stores various programs including a system program and a processing program executed by the control unit (not shown), and data required for executing these programs. For example, the storage unit stores setting information required for executing image forming process.

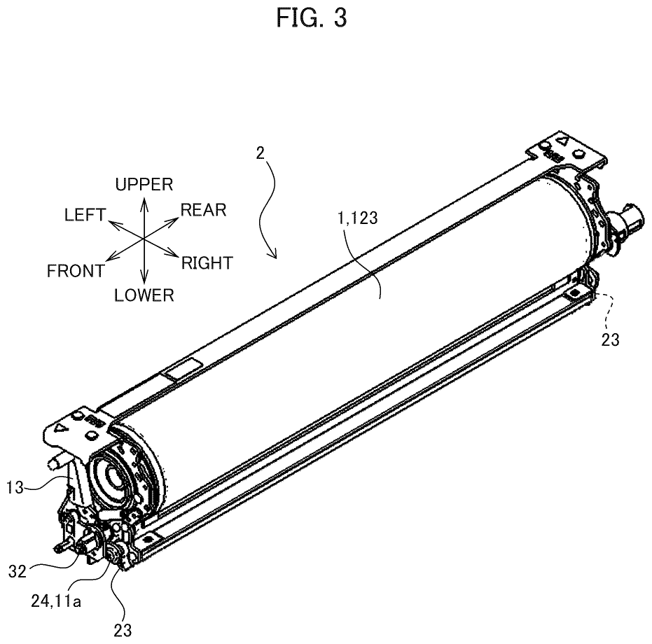

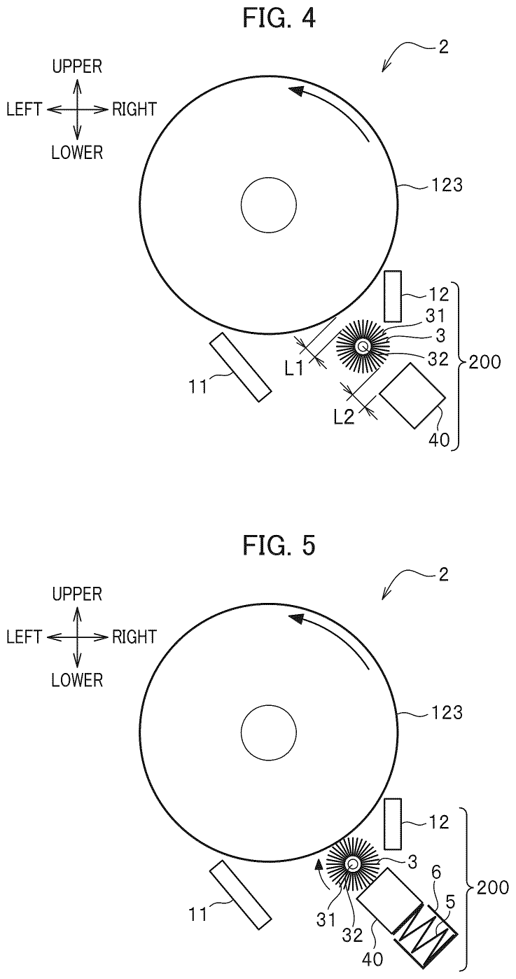

FIG. 3 is a schematic perspective view illustrating a photoconductor unit 2 including the lubricant application device 200. FIG. 4 is an explanatory view illustrating a state in which the application brush 3 of the lubricant application device 200 is separated from the photoconductor 123 as the application target and the lubricant bar 40 as the lubricant. FIG. 5 is an explanatory view illustrating a state in which the lubricant is applied to the photoconductor 123 as the application target by the application brush 3 of the lubricant application device 200. FIG. 6 is an explanatory view illustrating a state in which a fixing member 7 of the lubricant application device 200 is attached to the photoconductor unit 2.

### «Lubricant Application Device and Photoconductor Unit»

As shown in FIG. 4, FIG. 5, or FIG. 6, the lubricant application device 200 is a device for supplying the lubricant scraped off from the solidified lubricant bar 40 with the application brush 3 to the surface of the photoconductor 123 as the application target. The lubricant application device 200 is disposed downstream of the cleaning blade 11 (downstream in the rotation direction of the photoconductor 123).

The lubricant application device 200 includes the application brush 3, the lubricant bar 40, elastic members 5, cover members 6, a fixing member 7, and a blade 12.

As shown in FIG. 4 and FIG. 5, the photoconductor unit 2 includes the lubricant application device 200, the photoconductor 123, the cleaning blade 11, and the housing 8 shown in FIG. 6.

### <Application Brush>

The application brush 3 includes a roll-shaped brush member configured to apply the lubricant to the surface of the photoconductor 123 by bringing brush bristles 31 into sliding contact with the surface while the surface of the photoconductor 123 is being rotated. The application brush 3 includes a rotation shaft 32 supported by a bearing 33 (see FIG. 10) and an eccentric bearing 34, and brush bristles 31 extending in a centrifugal direction from an outer peripheral portion of the rotation shaft 32. The application brush 3 is set to rotate relative to the rotation of the photoconductor 123 (rotate in the clockwise direction (the direction of the arrow 3a)). The application brush 3 is installed so as to be in contact with both the lubricant bar 40 and the photoconductor 123, applies lubricant particles (lubricant powder) scraped off from the lubricant bar 40 to the photoconductor 123, and supplies the lubricant powder to the photoconductor 123.

As shown in FIG. 4, when the application brush 3 is stored or not used, the application brush 3 is separated from the photoconductor 123 by a distance L1, and the application brush 3 is separated from the lubricant bar 40 by a distance L2.

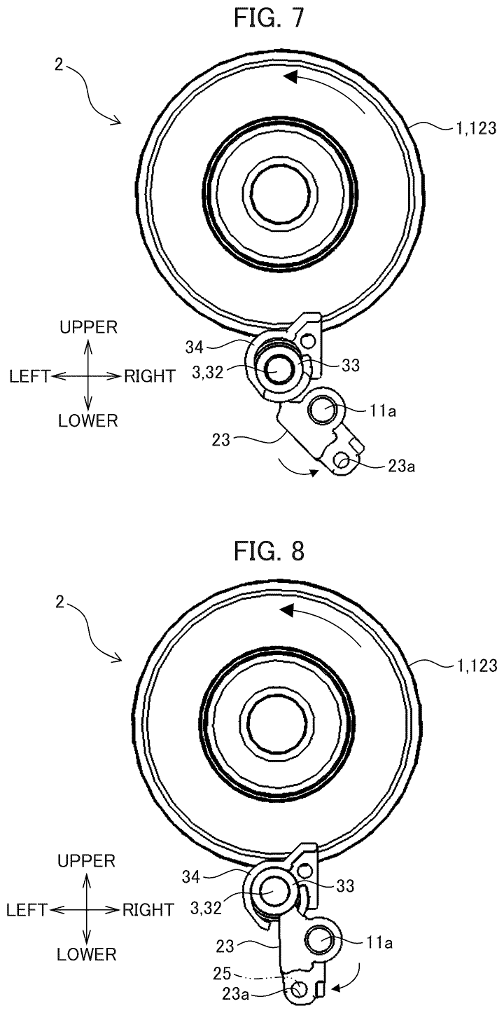

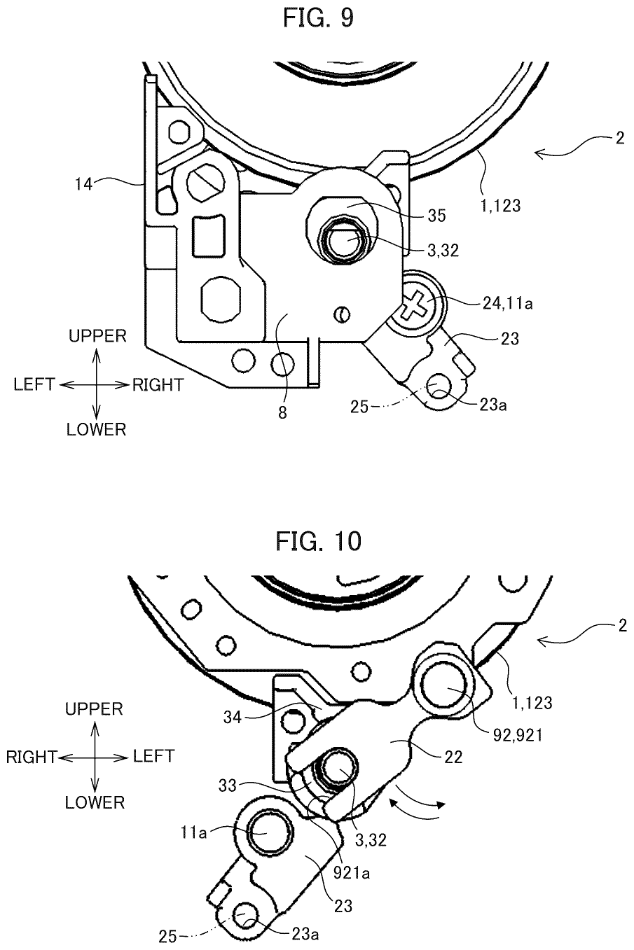

FIG. 7 is an explanatory view (a front view of a main part) illustrating a state in which the application brush 3 is separated from the photoconductor 123 by operating the lever 23. FIG. 8 is an explanatory view (a front view of a main part) illustrating a state in which the application brush 3 is brought into pressure contact with the photoconductor 123 by operating the lever 23. FIG. 9 is an explanatory view (a front view of a main part) illustrating an installation state of a fixed bearing 35 when the application brush 3 is separated from the photoconductor 123. FIG. 10 is an explanatory view (a rear view of a main part) illustrating an installation state of a plate member 22 when the application brush 3 is separated from the photoconductor 123.

As shown in FIG. 7 and FIG. 8, the application brush 3 is fixed at a position where the rotation shaft 32 of the application brush 3 is pushed up by the lever 23 rotatably attached to the outer peripheral portion of the photoconductor 123 to come into pressure contact with the photoconductor 123.

As shown in FIGS. 7, FIG. 9, and FIG. 10, the application brush 3 is supported by the eccentric bearing 34 when the application brush 3 is disposed at a position separated from the photoconductor 123.

As shown in FIG. 10, the application brush 3 is held at a position separated from the photoconductor 123 by attaching the plate member 22. As shown in FIG. 8, the application brush 3 is pressed against the outer peripheral surface of the photoconductor 123 by operating the lever 23.

### <Bearing>

As shown in FIG. 7 and FIG. 8, the bearing 33 is a member for pivotally supporting the rotation shaft 32 of the application brush 3, and is formed of, for example, a bearing. The bearing 33 is formed in the shape of an elongated hole, and as shown in FIG. 7, the bearing 33 is movably disposed at a separation position from the photoconductor 123 during storage of the photoconductor unit 2. As shown in FIG. 8, the application brush 3 maintains a pressure contact state in which the application brush 3 is pressed against and separated from the photoconductor 123 by the bearing 33 being in pressure contact with the inner surface of the eccentric bearing 34 having an elongated hole. Therefore, the application brush 3 can be easily fixed at a fixed position at all times.

### <Eccentric Bearing>

As shown in FIG. 7 and FIG. 8, the eccentric bearing 34 is a member that supports the bearing 33 when the application brush 3 is separated from the photoconductor 123 and supports the bearing 33 when the application brush 3 is in pressure contact with the photoconductor 123.

The eccentric bearing 34 is formed of a member having a frame-like portion formed in a substantially elliptical shape in a front view.

### <Lubricant>

The lubricant constituting the lubricant bar 40 shown in FIG. 4 is selected from materials (e.g., zinc stearate) that can be applied to the surface of the photoconductor 123 and that can reduce the surface energy of the photoconductor 123 to reduce the adhesion force between the toner and the photoconductor 123.

### <Lubricant Bar>

The lubricant bar 40 is obtained by solidifying a powdery lubricant. The lubricant bar 40 is formed by melting and molding the above-described material or by compression-molding particles of the above-described material and is formed in a shape (bar shape) that can be scraped off by the application brush 3.

### <Elastic Member>

As shown in FIG. 5, the elastic member 5 is a lubricant pressing member that presses the lubricant bar 40 toward the application brush 3 to keep the lubricant bar 40 in pressure contact with the application brush 3. The elastic member 5 includes a compressed coil spring or the like for pressing the lubricant bar 40 against the application brush 3 and pressing the application brush 3 against the photoconductor 123 with the lubricant bar 40 interposed therebetween. The elastic member 5 is supported by a cover member 6 which can be detachably attached to the housing 8. Therefore, the elastic member 5 is removable. For switching the elastic member 5 to the separated state in which the application brush 3 is separated from the photoconductor 123 and the lubricant bar 40, as shown in FIG. 4, the elastic member 5 is removed from the photoconductor unit 2 by removing the cover member 6 from the housing 8.

### <Cover Member>

The cover member 6 shown in FIG. 5 is a housing member for housing and supporting the elastic member 5 in a state of pressing the lubricant bar 40. The cover member 6 has an engagement portion (not shown) elastically locked to the housing 8 (see FIG. 6) by snap-fitting, with the opening side of the cover member 6 arranged at the end of the lubricant bar 40.

### <Fixing Member>

As shown in FIG. 6, the fixing member 7 is a member for fixing the lubricant bar 40 when the application brush 3 and the lubricant bar 40 are separated from each other. The fixing member 7 is installed such that, when the application brush 3 and the lubricant bar 40 are separated from each other, the proximal portion 7a thereof is locked and fixed to the housing 8 and the distal portion 7b thereof supports the lubricant bar 40 without rattling. In this way, the fixing member 7 is removably attached to the photoconductor unit 2.

### <Housing>

The housing 8 is a member for supporting the fixing member 7 and the blade 12 which are constituent parts of the photoconductor unit 2. The housing 8 is formed of metal plate members disposed at the front end portion and the rear end portion of the photoconductor unit 2. The lubricant bar 40, the cover member 6, the fixing member 7, the cleaning blade 11, and the blade 12 are integrated by housing 8.

### <Plate Member>

As shown in FIG. 10, the plate member 22 is a member for holding the application brush 3 at a position separated from the photoconductor 123. The plate member 22 has a proximal portion rotatably supported by a screw member 921, and a distal portion having a U-shaped groove 921a into which the rotation shaft 32 is inserted. The plate member 22 has the function of keeping a constant distance between the screw member 921 and the rotation shaft 32.

### <Lever>

The lever 23 is a substantially lever-shaped operation member. The lever 23, which is provided in a pair, is disposed respectively on the front and rear outer sides of the photoconductor unit 2 and can be operated by hand. As shown in FIG. 9, the lever 23 is rotatably disposed with the pivot shaft 11a of the cleaning blade 11 serving as a fulcrum. When the lever 23 is swingably operated, the application brush 3 can be separated from the photoconductor 123 as shown in FIG. 7, or the application brush 3 can be brought into pressure contact with the photoconductor 123 as shown in FIG. 8. Therefore, the application brush 3 and the lubricant bar 40 are separated from each other by independent operations. The application brush 3 and the lubricant bar 40 are disposed in the photoconductor unit 2 including the photoconductor 123 even in a state of being separated from each other. To maintain a state in which the application brush 3 shown in FIG. 8 is brought into pressure contact with the photoconductor 123. a screw insertion hole 23a into which a screw member 25 for fixing the lever 23 to the housing 8 is inserted is formed in a lower end portion of the lever 23.

### <Cleaning Blade>

As shown in FIG. 4 and FIG. 5, the cleaning blade 11 is formed, for example, by processing an elastic member such as polyurethane rubber into a flat plate shape (sheet shape). The cleaning blade 11 is a component of a cleaning device (not shown) that is installed such that a distal end of the cleaning blade 11 slides on the photoconductor 123 and scrapes off and removes adhering substances such as untransferred toner remaining on the surface of the photoconductor 123. The cleaning blade 11 is brought into contact with the photoconductor 123, and removes residual substances such as residual toner, paper dust, and external additives remaining on the surface of the photoconductor 123 after the primary transfer.

The cleaning device is configured to include the cleaning blade 11, a waste toner conveying screw (not shown) that discharges the residue to the outside of the device, and a case (not shown) that accommodates the cleaning blade 11 and the like.

### <Blade>

The blade 12 shown in FIG. 6 is a member for spreading and applying the lubricant powder supplied to the photoconductor 123 onto the photoconductor 123 to form a film, by a contact pressure at which the blade 12 comes into contact with the photoconductor 123. The blade 12 is held by a holding portion (not shown) of the housing 8 on the downstream side of the application brush 3 and is disposed in contact with the photoconductor 123.

### <Attachment Mechanism>

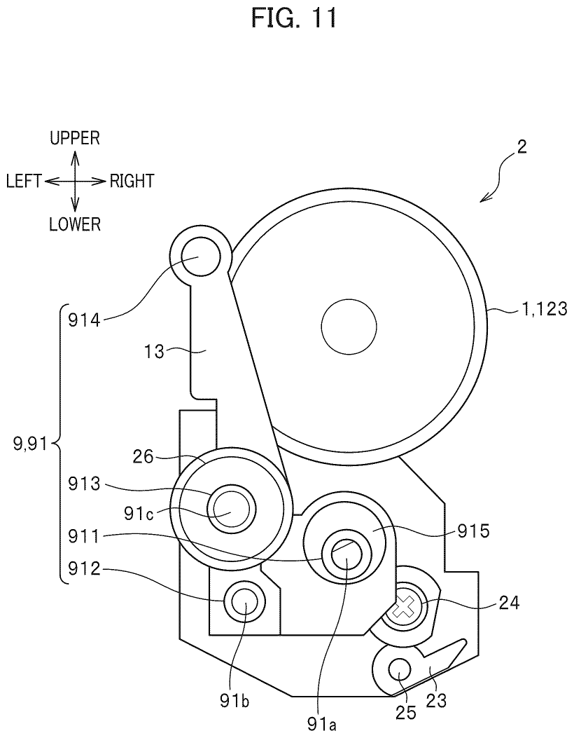

The attachment mechanism 9 shown in FIG. 11 is a mechanism for attaching the application brush 3 to the photoconductor unit 2. The attachment mechanism 9 includes a first attachment mechanism 91 disposed on the front side of the photoconductor unit 2 and a second attachment mechanism 92 (see FIG. 10) disposed on the rear side of the photoconductor unit 2. The first attachment mechanism 91 and the second attachment mechanism 92 are configured by different mechanisms.

### <First Attachment Mechanism>

As shown in FIG. 11, the first attachment mechanism 91 includes a fixed bearing 915, a retaining ring 911 for mounting a fixing member (not shown) and gears on a shaft 91a, a retaining ring 912 for mounting gears 27 and a bearing 29 on a shaft 91b, a retaining ring 913 for mounting gears 26 on a shaft 91c, and a positioning pin 914 for supporting a cleaning blade fixing member 13. The retaining rings 911, 912, and 913 are, for example, E-shaped retaining rings. Thus, the first attachment mechanism 91 does not include a screw. Therefore, compared to using screws, the first attachment mechanism 91 offers advantages such as ease of installation, suitability for narrow spaces, low cost, high load and vibration resistance, and greater durability.

Note that the lever 23 is supported by a pivot shaft 24. The cleaning blade 11 is rotatably supported by the pivot shaft 24. The cleaning blade fixing member 13 is supported by a positioning pin 914 and an engagement portion 14 (see FIG. 9).

### <Second Attachment Mechanism>

As shown in FIG. 10, the second attachment mechanism 92 includes a screw member 921 for pivotally supporting the plate member 22.

«Order of Separating Application Brush from Photoconductor and Lubricant Bar»

As shown in FIG. 4, when the application brush 3 is separated from the photoconductor 123 and the lubricant bar 40, first, the cover members 6 located on the front and rear sides of the photoconductor unit 2 illustrated in FIG. 5 are removed from the photoconductor unit 2. Subsequently, the elastic members 5 disposed on the front and rear sides of the photoconductor unit 2 are removed. By removing the elastic members 5 from the photoconductor unit 2, the lubricant bar 40 is not urged toward the application brush 3, and therefore, as shown in FIG. 4, the lubricant bar 40 can be separated from the application brush 3.

Next, as shown in FIG. 6, the fixing members 7 are attached to the front and the rear of the photoconductor unit 2, respectively, and the lubricant bar 40 is fixed with the fixing members 7 in a state of being separated from the application brush 3. Subsequently, the screw member 25 of the lever 23 on the rear side of the photoconductor unit 2 illustrated in FIG. 10 is removed.

Next, the two retaining rings 911, 912 and the gears (not shown) provided on the shafts 91a, 91b on the front side of the photoconductor unit 2 as shown in FIG. 11 are removed. Further, the bearings (not shown) respectively provided on the shafts 91a, 91b are removed.

Next, the screw member 25 of the lever 23 disposed on the front side of the photoconductor unit 2 is removed. The lever 23 on the front side is turned from the state illustrated in FIG. 8 to the state illustrated in FIG. 7. Then, the application brush 3 moves in a direction away from the photoconductor 123 and becomes separated from the photoconductor 123.

Next, the fixed bearing 915 is attached to the shaft 91a on the front side of the photoconductor unit 2. Subsequently, the cleaning blade 11 on the front side of the photoconductor unit 2 is separated from the photoconductor 123 by the cleaning blade fixing member 13 (see FIG. 4).

Next, at the same time as the separation of the cleaning blade 11 from the photoconductor 123, the plate member 22 that allows the application brush 3 to be separated from the photoconductor 123 is fixed by the rotation shaft 32 and the screw member 921 in a state where the application brush 3 is separated from the photoconductor 123 (see FIG. 6 or 10). Note that the screw member 921 illustrated in FIG. 10 also plays a role of separating the cleaning blade 11 from the photoconductor 123.

In this way, as shown in FIG. 4, the application brush 3 can be held in a state of being separated from the photoconductor 123 and the lubricant bar 40.

«Order of Bringing Application brush into Pressure Contact with Photoconductor and Lubricant Bar»

As shown in FIG. 5, when the application brush 3 is brought into pressure contact with the photoconductor 123 and the lubricant bar 40, first, the plate member 22 is removed by removing the screw member 921 on the rear side of the photoconductor unit 2 shown in FIG. 10.

Next, the cleaning blade fixing member 13 on the front side of the photoconductor unit 2 shown in FIG. 11 is removed from the photoconductor unit 2, and the cleaning blade 11 is brought into pressure contact with the photoconductor 123 (see FIG. 5).

Subsequently, the fixed bearing 915 on the front side of the photoconductor unit 2 is removed from the photoconductor unit 2.

Next, the lever 23 on the front side of the photoconductor unit 2 is turned from the state illustrated in FIG. 7 to the state illustrated in FIG. 8. Then, the application brush 3 moves in the pressing direction in which the application brush 3 comes into pressure contact with the photoconductor 123 and comes into pressure contact with the photoconductor 123.

Subsequently, the lever 23 is fixed to an application brush pressure contact position at which the application brush 3 is in pressure contact with the photoconductor 123 by the screw member 25 shown in FIG. 11.

Next, the lever 23 on the rear side of the photoconductor unit 2 illustrated in FIG. 10 is rotated to bring the application brush 3 into pressure contact with the photoconductor 123. Then, the screw member 25 is attached to a screw insertion hole 23a of the rear lever 23 to fix the application brush 3 at the application brush pressure contact position where the application brush 3 is in pressure contact with the photoconductor 123.

Subsequently, the bearings (not shown) are attached to the shafts 91a, 91b disposed on the front side of the photoconductor unit 2 shown in FIG. 11. Further, the gears (not shown) are fitted to the shafts 91a, 91b, respectively, and the retaining rings (not shown) are attached to the shafts 91a, 91b, so that the gears (not shown) are held on the shafts 91a, 91b.

Next, the fixing member 7 illustrated in FIG. 6 is removed from the supporting lubricant bar 40.

Subsequently, as shown in FIG. 5, the elastic members 5 that urge the lubricant bar 40 disposed on the front and rear sides of the photoconductor unit 2 are attached. Then, the cover members 6 are attached to the front and rear of the photoconductor unit 2, respectively, to hold the elastic members 5. Further, adhesive tape (not shown) is attached to the front and rear cover members 6 of the photoconductor unit 2, and the cover members 6 are attached to the housing 8 (see FIG. 6).

In this way, the application brush 3 shown in FIG. 5 can be held in pressure contact with the photoconductor 123, and the lubricant bar 40 can be held in pressure contact with the application brush 3.

As described above, the lubricant application device 200 according to the present invention shown in FIG. 4, includes the application brush configured to apply the lubricant to the surface of the photoconductor 123 by bringing the brush bristles 31 into sliding contact with the surface while the surface of the photoconductor 123 is being rotated. The lubricant application device 200 is configured such that the application brush 3 can come into pressure contact with and separate from the photoconductor 123 and such that the application brush 3 can come into pressure contact with and separate from the lubricant bar 40.

According to this configuration, the lubricant application device 200 of the present invention can always separate the application brush 3 from the photoconductor 123 and the lubricant bar 40 when the application brush 3 is not used. In the lubricant application device 200, the device for separating the application brush 3 from the photoconductor 123 and the lubricant bar 40 can be installed in a limited space, thereby preventing the overall device from becoming larger in size.

Further, in the lubricant application device 200, the application brush 3 can be separated from the photoconductor 123 and the lubricant bar 40. Accordingly, when the lubricant is not used for a long period of time, a pressing force for pressing the lubricant bar 40 can be eliminated. As a result, deformation or tilt of the brush bristles of the application brush 3 can be prevented, enabling uniform application of lubricant to the photoconductor and the intermediate transfer member, and thereby preventing image density unevenness.

Further, as shown in FIG. 7 and FIG. 8, the bearing 33 of the application brush 3 is formed in the shape of an elongated hole and is arranged so as to be movable to the separation position from the photoconductor 123 during storage.

According to this configuration, the bearing 33 of the application brush 3 can be moved to and arranged at a position separated from the photoconductor 123 during storage when the lubricant is not used, and the application brush 3 can be placed away from the lubricant bar 40. For this reason, the time during which the application brush 3 is kept in pressure contact with the lubricant bar 40 can be reduced, thereby preventing deformation or tilting of the brush bristles. As a result, the application brush 3 can evenly apply the lubricant to the photoconductor 123 during the application of the lubricant.

Further, as shown in FIG. 7 and FIG. 8, the application brush 3 is fixed at the pressure-contact position by pushing up the rotation shaft 32 of the application brush 3 with the lever 23 that is rotatably attached to the outer peripheral portion of the photoconductor unit 2 including the photoconductor 123.

According to this configuration, the lever 23 is rotated about the pivot shaft 24, and pushes up the rotation shaft 32 of the application brush 3 via the bearing 33, thereby moving the application brush 3 to the pressure-contact position at which the application brush 3 is in pressure-contact with the photoconductor 123. Therefore, the application brush 3 can be easily held in a state of being in pressure contact with the photoconductor 123 by rotating the lever 23.

Further, as shown in FIGS. 4, FIG. 5, FIG. 7 and FIG. 8, the application brush 3 and the lubricant bar 40 obtained by solidifying the lubricant are separated from each other by independent operations.

According to this configuration, the application brush 3 and the lubricant bar 40 are separated from each other by independent operations, which can increase the degree of freedom in the structure of the mechanisms for separating the application brush 3 and the lubricant bar 40. Therefore, the lubricant application device 200 can be downsized.

Furthermore, as shown in FIG. 4, the application brush 3 and the lubricant bar 40 obtained by solidifying the lubricant are disposed in the photoconductor unit 2 including the photoconductor 123 even in a separated state.

According to this configuration, even in a state where the application brush 3 and the lubricant bar 40 are separated from each other, the application brush 3 and the lubricant bar 40 are disposed in the photoconductor unit 2 including the photoconductor 123, thereby preventing the entire photoconductor unit 2 from being increased in size.

Further, as shown in FIG. 6, the application brush 3 and the lubricant bar 40 are separated from each other by removing the elastic member 5 and fixing the lubricant bar 40 with the fixing member 7, and the fixing member 7 is disposed to so as to be detachable from the photoconductor unit 2.

According to this configuration, the application brush 3 and the lubricant bar 40 are separated from each other by removing the elastic member 5 and fixing the lubricant bar 40 to the housing 8 with the fixing member 7. Since the fixing member 7 is disposed to so as to be detachable from the photoconductor unit 2, the fixing member 7 can be attached as needed and removed when not required.

Further, as shown in FIG. 7 and FIG. 8, the lubricant application device 200 includes the lever 23 disposed outside the photoconductor unit 2 and operable by hand.

According to this configuration, since the lever 23 is provided outside the photoconductor unit 2, the lever 23 can be disposed at a position where the lever 23 can be easily operated by hand.

Further, as shown in FIG. 7, the application brush 3 is supported by the eccentric bearing 34 when the application brush 3 is disposed at a position separated from the photoconductor 123.

According to this configuration, since the application brush 3 is supported by the eccentric bearing 34 when the application brush 3 is disposed at a position separated from the photoconductor 123, the application brush 3 can be supported so as not to fall off even when the rotation shaft 32 of the application brush 3 moves.

Further, as shown in FIG. 10, the application brush 3 is held by the plate member 22 when the application brush 3 is held at a position separated from the photoconductor 123.

According to this configuration, since the application brush 3 can be held in a state of being separated from the photoconductor 123 by fixing the plate member 22, the separated state of the application brush 3 can be held by an easy operation.

Further, as shown in FIG. 9, the lever 23 is disposed so as to be pivotable about the pivot shaft 24 of the cleaning blade 11.

According to this configuration, since the lever 23 is disposed so as to be pivotable about the pivot shaft 24 of the cleaning blade 11, the pivot shaft 24 can be used as a shaft for both the lever 23 and the cleaning blade 11. Therefore, the rotating shaft 24 can contribute to the reduction in the number of components and man-hours for assembly, thereby achieving a reduction in manufacturing cost.

Further, as shown in FIG. 4 and FIG. 5, the application brush 3 applies the lubricant when the application brush 3 is pressed against the photoconductor 123.

According to this configuration, since the application brush 3 applies the lubricant and the brush bristles 31 can be impregnated with the lubricant, the lubricant can be applied to the photoconductor 123 that is in pressure contact with the application brush 3.

As shown in FIG. 7 and FIG. 8, the application brush 3 is brought into pressure contact with the photoconductor 123 by operating the lever 23.

According to this configuration, by operating the lever 23, the application brush 3 can be easily disposed at a predetermined position where the application brush 3 is brought into pressure contact with the photoconductor 123, and the lubricant can be applied.

As shown in FIG. 10 or FIG. 11, the attachment mechanism 9 for attaching the application brush 3 to the photoconductor unit 2 includes the first attachment mechanism 91 and the second attachment mechanism 92 that are disposed at front and rear of the photoconductor unit 2, and the first attachment mechanism 91 and the second attachment mechanism 92 are configured as different mechanisms.

According to this configuration, in the attachment mechanism 9 for attaching the application brush 3 to the photoconductor unit 2, the first attachment mechanism 91 and the second attachment mechanism 92 disposed on the front and rear sides of the photoconductor unit 2 are different from each other, and thus the configurations of the first attachment mechanism 91 and the second attachment mechanism 92 can be freely set.

Further, as shown in FIG. 1, the image forming apparatus 100 includes the lubricant application device 200.

According to this configuration, since the image forming apparatus 100 includes the lubricant application device 200, deformation or tilt of the brush bristles of the application brush 3 can be prevented during storage. This enables uniform application of the lubricant to the photoconductor 123 when the application brush 3 is in use, thereby preventing image density unevenness.

Although one embodiment of the present invention has been described and illustrated in detail, the disclosed embodiment is made for purposes of illustration and example only and not limitation. The scope of the present invention should be interpreted by terms of the appended claims.

What is claimed is:

1. A lubricant application device comprising:
an application brush configured to apply a lubricant to a surface of an application target by bringing brush bristles into sliding contact with the surface while the surface of the application target is being rotated, wherein
the application brush is configured to come into pressure contact with and separate from the application target, and the application brush is configured to come into pressure contact with and separate from the lubricant.

2. The lubricant application device according to claim 1, wherein a bearing of the application brush is formed in the shape of an elongated hole and is arranged so as to be movable to a separation position from the application target during storage.

3. The lubricant application device according to claim 1, wherein the application brush is fixed at a pressure-contact position by pushing up a rotating shaft of the application brush with a lever that is rotatably attached to an outer peripheral portion of a unit including the application target.

4. The lubricant application device according to claim 1, wherein the application brush and the lubricant bar obtained by solidifying the lubricant are separated from each other by independent operations.

5. The lubricant application device according to claim 1, wherein the application brush and the lubricant bar obtained by solidifying the lubricant are disposed in a unit including the application target even in a state of being separated from each other.

6. The lubricant application device according to claim 3, wherein the application brush and the lubricant are separated from each other by removing an elastic member and fixing the lubricant with a fixing member; and
the fixing member is disposed to so as to be detachable from the unit.

7. The lubricant application device according to claim 3, further comprising a lever disposed outside the unit and operable by hand.

8. The lubricant application device according to claim 1, wherein the application brush is supported by an eccentric bearing when the application brush is disposed at a position separated from the application target.

9. The lubricant application device according to claim 1, wherein the application brush is held by a plate member when the application brush is held at a position separated from the application target.

10. The lubricant application device according to claim 7, wherein the lever is disposed so as to be pivotable about a pivot shaft of the cleaning blade.

11. The lubricant application device according to claim 1, wherein the application brush applies the lubricant when the application brush is pressed against the application target.

12. The lubricant application device according to claim 3, wherein the application brush is brought into pressure contact with the application target by operating the lever.

13. The lubricant application device according to claim 3, wherein an attachment mechanism for attaching the application brush to the unit includes a first attachment mechanism and a second attachment mechanism disposed at front and rear of the unit, and
the first attachment mechanism and the second attachment mechanism are configured by different mechanisms.

14. An image forming apparatus comprising the lubricant application device comprising the lubricant application device according claim 1.
